(19) United States
(12) Patent Application Publication
(10) Pub. No.: US 2006/0183531 A1
(43) Pub. Date: Aug. 17, 2006

(54) Gaming machine

(76) Inventor: Arthur Edward Thomas, Cardiff (GB)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/549,971

(22) PCT Filed: Mar. 25, 2004
(86) PCT No.: PCT/GB04/01319

§ 371 Date: Sep. 20, 2005

(30) Foreign Application Priority Data
Mar. 27, 2003 (EP) 03251918.3
Dec. 10, 2003 (EP) 03257769.4

(51) Int. Cl. G06F 19/00

(52) U.S. Cl. 463/18

(57) ABSTRACT

A gaming machine allows the playing of a lottery game involving a group of individual main games each of which results in a win in dependence upon the number of matches between the symbols selected by a player and a randomly-selected set of symbols. In addition, there are bonus games which are won in dependence upon the correspondence between the bonus game sets of an individual player (each formed by symbols in corresponding positions within the sequences of his main game sets) and randomly-selected bonus game sets (each formed by symbols at corresponding positions within the different randomly-selected main game sets).

### BACKGROUND OF THE INVENTION

1. Field of the Invention

This invention relates to gaming machines, which term is used herein to refer to any device by means of which a user can play a game and, depending upon the resluts of the game, obtain a credit value. The users preferably pay for the game using one or more payment media such as cash (coin and/or banknotes), smart cards, credit cards, vouchers or tokens, and the machines preferably pays out an amount corresponnding to the credit value, also using one or more of the payment media.

Herein, the term “gaming machine” is used to cover not only those machines which issue payment equivalent to particular cash amounts, but also those which award prizes instead of, or in addition to, cash-equivalent payments. The invention is applicable in a variety of different areas of gaming, such as dedicated user-operable stand-alone machines and on-line systems in which each user operates his own terminal, the game-playing control system possily being located remote form the terminal.

2. Description of the Prior Art

Lottery games are very popular and it has thus been prposed to produce gaming machines which permit the playing of such games. The designers of lottery games have attempted in the past to increase the attraction of the games to prospective players using a variety of different techniques. However, a difficulty faced by the designers is that player-interest tends to be transient and quickly fades. Whenever the result of a lottery game is made known, the losing players quickly become discouraged.

It would be desirable to provide an improved lottery game machine in which the interest of the players is maintained, and even enhanced over a relatively long period, even for players with losing results.

### SUMMARY OF THE INVENTION

Aspects of the invention are set out in the accompanying claims.

According to a further aspect of the invention, a lottery game machine provides main lottery games which are collected into groups. The individual games within each group are played sequentially, and if desired in a manner which is known per se. Thus, for example, for a particular game player may select a group of symbols, such as numbers, from a larger set. A game result is then obtained by randomly selecting symbols, and the results of the game for a player will depend upon how many of the symbols he has selected match the randomly-selected symbols.

According to this further aspect of the invention, hoowever, players also take part in one (or prefereably more) bonus games. Each bonus game involves the comparison between (a) a random bonus game set formed by choosing symbols form the various results for the group of main games, and (b) a player's bonus game set, which is formed by symbols chosen from the various sets selected by thhe player for the main games. Thus, for example, a player will win a bonus game if his bonus game set (consisting of one symbol from each of the sets he chose for the respective main games) matches a random bonus game set (consisting of one of the symbols from each of the result sets for the different main games).

As a result of this arrangement, even though a player may lose a main game, his interest is nevertheless maintained because he knows that he may, when the group of main games has been completed, win a bonus game. The fact that the main games are played progressively extends the period of interest and suspense. Also, any favourite numbers he has selected for a particular main game may represent losing numbers for that game, but winning numbers for the bonus game, so that enhanced enjoyment is provided by avoiding the disillusionment accompanying the recognition that favourite numbers have been unsuccessful.

In order to compile the random bonus game set, it is necessary to choose particular symbols in different randomly-selected main game results. Preferably, only one symbol is selected from each main game result. In order to facilitate understanding of the game, and to avoid suspicions of improper symbol selection, preferably the bonus game set consists of symbols chosen in a systematic way from each of the random main game sets. In accordance with a further aspect of the invention, the symbols within each main game result set form a sequence, and a bonus game set is made up of symbols from the main game result sets which are in corresponding positions in the sequences. Thus, if the symbols are numeric, the symbols within each main game result set could be arranged in numerical order, and the bonus game set could be formed from a combination of the lowest numbers of the respective main game sets. (Similar considerations apply if the symbols are alphabetic. In the preferred embodiment, the symbols are alphanumeric, i.e. alphabetic and/or numeric.) Alternatively, the symbols within each main game result set could be considered to be in the order in which they were randomly selected, and a bonus game set could be formed by combining the first-selected symbol from each of the main game result sets. (In the latter case, each main game preferably involves indicating to the players the order in which the symbols are randomly selected.)

Preferably, the symbols forming a player's bonus game set are selected in a corresponding manner. That is, each of the player-selected main game sets comprises symbols in a sequence, and a bonus game set for the player comprises symbols from his different main game sets which are located at corresponding positions within the sequences. However, this is not essential; the player could choose specific symbols within his different main game sets to form a bonus game set.

Preferably, each group of main games corresponds to multiple bonus games. Thus, each bonus game set may comprise a single symbol from each main game set, so that the number of bonus games may be equal to the number of symbols within each main game set.

The number of symbols within each bonus game set may also correspond to the number of main games within the main game group. This also however is not essential: some main games within a particular group may not contribute towards the bonus games, and/or other main games may contribute more than one symbol to a particular bonus game set.

It will be appreciated from the foregoing that the number of symbols within a bonus game set may not be equal to the number of symbols within a main game set. Accordingly, the requirements for winning a main game, and the amounts won, may differ from those for a bonus game. For example, more or fewer matching symbols may be required for the minimum win. Other factors may influence the odds of winning, and consequently the amounts won:
(1) Preferably, whenever a main game set is selected by the player or the machine, a “without replacement” selection procedure is used, whereby duplicate symbols within a particular main set are avoided. However, bonus sets could include duplicate symbols, thus affecting the odds of winning.
(2) According to the arrangement described above, multiple bonus games are provided only after a group of main games has been played. Preferably, however, the player is given additional opportunities to play bonus games. It is felt to be particularly valuable to avoid the need for the player to commit to playing (and paying for) multiple main games in order to obtain bonus games. Also, the provision of further bonus games at reasonably frequent intervals adds to the player's interest.

One way of implementing this feature would be for the machine to provide, each time a main game is played and/or paid for, a random number of bonus games, the number ranging preferably from zero to the maximum possible number of bonus games (e.g. the number of symbols within each main game set). When the main game is played, the machine displays symbols for the additional bonus games (if any) which are awarded, in addition to the player-selected and randomly-selected symbols for the main game. These additional bonus game symbols may all be selected randomly.
(3) The apparatus may have provision for altering previously-selected symbols (either player-selected or randomly-selected) relating to already-played games. This operation could be initiated by the player, or by the machine on random occasions.
(4) Certain of the randomly-selected symbols may be treated as “wild card” symbols for the purpose of the bonus games. That is, any symbol of a player's set may, for the purpose of the bonus game, be regarded as matching a wild card symbol. Preferably, the choice of which symbols are to be regarded as wild card symbols is not made (or is not announced to the player) until after the main game group has been completed. In this way, as the main games are progressively completed, the player's interest can be maintained even if he finds that his bonus game sets contain relatively few matching symbols.

The present invention comprises a complete apparatus for playing a lottery game, including means allowing a player to select his symbols, means for presenting to the player the randomly-selected symbols and means for computing whether the player has won a main game or a bonus game. The invention also extends to elements of such a system which are specifically arranged to enable or facilitate the operation of the system, such as the computing means which computes the main game and bonus game wins, entry means for accepting player-selections and for representing those selections in a manner that facilitates the viewing of the player's main game sets and bonus game sets, presenting means for displaying the randomly-selected symbols in a manner permitting the main game result sets and random bonus game sets to be readily perceived, etc.

### BRIEF DESCRIPTION OF THE DRAWINGS

Arrangements embodying the invention will now be described by way of example with reference to the accompanying drawings, in which:

FIG. 1 shows a gaming machine in accordance with the invention;

FIG. 2 illustrates by way of an example a display provided by the machine of FIG. 1;

FIG. 3 shows the display of FIG. 2 at a different stage of play;

FIG. 4 is a schematic illustration of a first multi-terminal gaming system in accordance with the invention; and

FIG. 5 is a schematic illustration of a second multi-terminal gaming system in accordance with the invention.

### DETAILED DESCRIPTION OF THE PREFERRED EMBODIMENTS

Gaming Machine

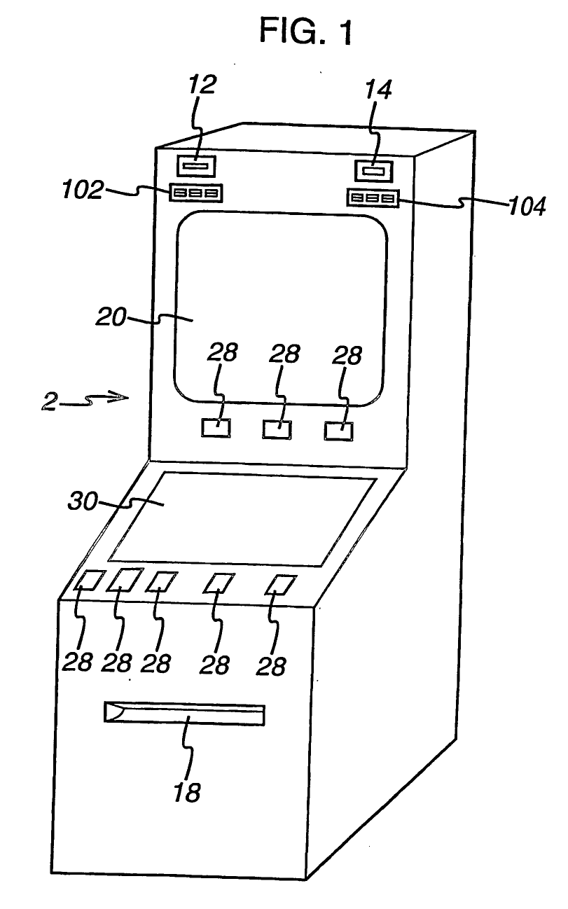

Referring to FIG. 1, a gaming machine 2 is arranged to receive coins and tokens through slots 12 and 14, and to deliver coins or tokens to a tray 18 if a player wins a prize. Provision may be made for payment or prizes to be in other forms than cash or tokens, for example by use of a credit or debit card.

The machine 2 also has two video screens, 20, 30 which in this embodiment are both screens of cathode ray tube monitors. As will be described, these provide displays of various game features, including simulated symbol-carrying reels. Other types of electrically alterable display screens can be used, such as LCD or projection displays, and indeed at least some of the game features could be embodied in electro-mechanical arrangements.

The machine 2 also has various push-buttons 28 allowing the player to initiate various operations and make various selections in order to play a game. FIG. 1 shows these as physical push-buttons operating electrical switches, but some or all could alternatively be replaced by display areas of the screens 20, 30, the player being able to provide instructions to the machine by selecting these display areas, which can be achieved either by movement of a cursor or, preferably, by physically touching the display areas, for which purpose the screens 20, 30 are preferably touch screens.

Gaming machines having touch-responsive video screens by means of which players can play games, are very well known in the art, and anyone skilled in the art will be easily capable of designing and constructing the necessary hardware. Furthermore, the software techniques required to produce the necessary displays and to operate the games are well known to those skilled in the art, and the necessary modifications required in order to provide the displays and games described below will be clear. Also, other means may be provided for player operation, such as voice actuation.

Display/Controls

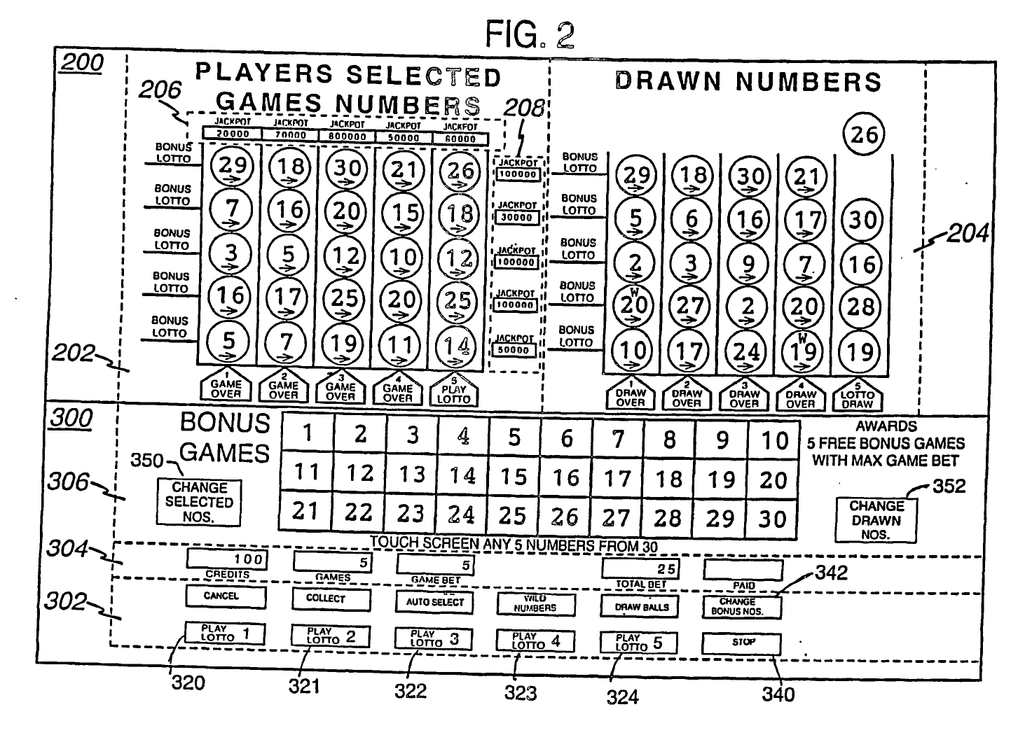

Referring to FIG. 2, this schematically illustrates an example of the displays that can be provided by the screens 20, 30. This includes two main display areas 200, 300, which illustrate the displays provided by the screens 20, 30 respectively. For the purposes of FIG. 2, it is assumed that the physical switches 28 of FIG. 1 are replaced by display screen areas.

The main area 300 includes an input area 302 in which are displayed a number of simulated push-buttons by means which the player can instruct the operation of the machine. For example, the area allows the player to select whether any winnings are to be collected or are to remain available as stakes for succeeding games, whether he wishes the machine automatically to select symbols for his use (so that the player does not need to select them manually), etc. There are also simulated push buttons for initiating the individual games. Means may be provided to allow adjustment of the amount of stake placed on each game.

A summary indication area 304 includes sub-areas displaying information concerning the consequences of the instructions received from the player and the results of games played by the player, such as the amount of credit owed to the player, the number of games selected, the amount of stake bet on each game, the total amount which is being bet and the total amount which has been paid out to the player.

A symbol selection area 306 allows the player individually and sequentially to select symbols for forming player-selected sets for use in the games.

The main area 200 comprises a player selection region 202 and a machine selection region 204. These regions respectively display player-selected and machine-selected symbols relating to a group of main games (a group in this embodiment consisting of five main games). Within each region, the symbols are displayed in an array, with the symbols for each main game forming a respective column. There are five symbols for each main game, and the symbols are displayed from bottom to top in the order in which in they are selected. The sets of main game symbols are arranged from left to right in the order in which the main games are played.

Each set of symbols formed by a respective row of the array constitutes a bonus game set for the player (within the region 202) or for the machine (within the region 204), as will be explained below.

Main Games

A single main game can be played as follows.

In an initial state of the machine, the regions 202 and 204 are empty of displayed symbols. The player operates a simulated button 320 within the region 302 to indicate that he wants to play a first main game and (if this facility is provided) to select the amount of stake to be placed on the game. He then uses the region 306 to select five symbols in succession (the symbols in this embodiment being numerical). As he selects each symbol, a corresponding symbol is added to the region 202 within the left-most column corresponding to the main game, starting at the bottom and progressing upwardly. Each time a particular symbol has been selected, the indicia corresponding to that symbol within the region 306 changes state (e.g. is illuminated at a lower intensity), to indicate that the symbol cannot be selected again within that main game. In other words, it is ensured that all the player-selected symbols for a particular main game are different, by using a “without replacement” selection scheme. (The states of the indicia are reset at the beginning of each main game, so that the player can select the same symbols as were selected in a preceding game, although again within a single game the selected symbols must be unique.)

After he has selected his five symbols, the player then operates the simulated push button 320 again to initiate the machine symbol selection operation. The machine then selects five symbols at random, using a without replacement selection operation, each selected symbol then being shown in turn, starting from the bottom, within the left-most column of region 204 corresponding to the first main game. (Preferably, each time a symbol is selected by a player or by the machine, the area 200 shows that symbol as a simulated ball dropping on to the top of the respective column.)

The machine computes a win on the basis of comparing the player-selected symbols represented in the left column of region 202 with the machine-selected symbols represented in the left column of region 204. The machine will then award a win in dependence upon the number of matching symbols, as in a standard lottery or Keno game. The amount won will be dependent upon the number of matching symbols. An indication in area 206 of region 202, above the column, shows the amount which could be won (or the amount by which the stake is multiplied to form the winnings) if all five symbols match.

This operation can be repeated in order to play successive main games, using respective different columns within the regions 202 and 204. The further four main games are initiated by using simulated push buttons 321 to 324. For the purposes of clarity, FIG. 2 shows the regions 202 and 204 in the state adopted near the end of the fifth game, with the regions almost filled with symbols.

After all five main games have been played, and the main game and bonus game wins have been calculated and paid out, the regions 202 and 204 are cleared of symbols, so a new set of games can be started.

Bonus Games

If a player elects to play all five main games within a group, he is (in a first embodiment) automatically awarded five free bonus games. In this case, immediately after the fifth game has been played, the machine indicates the results of the bonus games by comparing player-selected bonus game sets with machine-selected bonus game sets.

Thus, for example, a player's bonus game set formed by the five lowermost symbols in the columns of region 202 is compared with the corresponding row of symbols in the region 204, and a win is awarded in dependence on whether there are matching symbols in the two sets. The amount of the award will depend upon the number of matching symbols and the total amount of stake placed on the five main games. Similarly, wins can result from other player-selected bonus sets formed by the remaining rows in the region 202, which are compared with the corresponding rows in the region 204. The amount which could be won if all five symbols within each bonus game set are found to match is represented by displays at the ends of the respective lines within an area 208.

It will be noted that within each bonus game set, either a player-selected set or a machine-selected set, the same symbol may occur more than once. This influences the odds of a given number of symbol-matches occurring.

It will be noted also that the symbols within each bonus game set are dependent not only upon the symbols selected by the player for the main games, but also the order in which those symbols were selected, thus adding to the interest of the game.

In a modified and preferred embodiment, the number of bonus games awarded when the player plays the fifth main game is randomly selected between zero and five. This is described in more detail below.

Additional Bonus Games

Whenever a player operates one of the simulated push buttons 320 to 324 to initiate a respective main game, the machine determines on a random basis whether or not to award the player one or more free bonus games. The player may be awarded up to five free bonus games each time a main game is played, corresponding to the five horizontal lines within the display region 202.

The arrangement is such that the machine determines which lines correspond to the free bonus games which have been awarded. The player selects symbols for the main game (corresponding to a vertical column) in the normal way. However, when he selects a symbol which appears on a line for which a free bonus game is awarded, the rest of the line is filled with randomly-selected bonus symbols for use in the free bonus game.

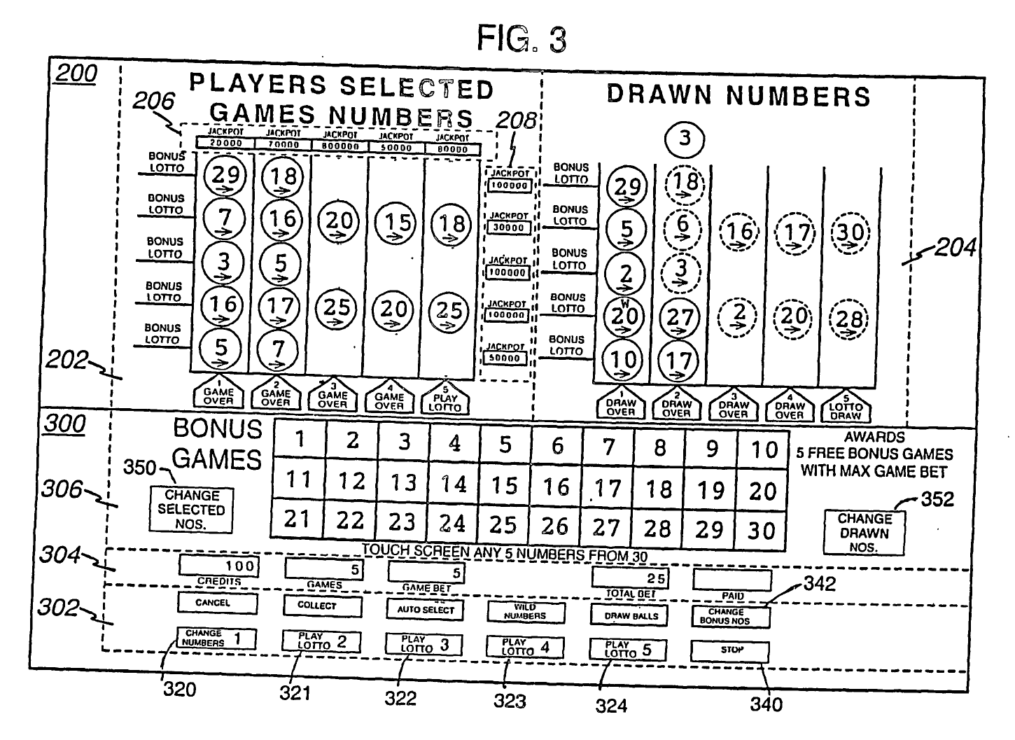

An example of this is shown in FIG. 3. This shows the state of the display areas 200, 300 part-way through the second main game. The player has sequentially selected all his symbols for the second game, namely symbols “7”, “17”, “S”, “16” and “18”. The machine has awarded two free bonus games, associated with horizontal lines 2 and 4. Thus, when symbol “17” was selected, the remainder of horizontal line 2 was filled with randomly-selected bonus symbols “25”, “20” and “25”. Similarly, when the fourth symbol “16” was selected by the player, the remainder of the fourth horizontal line was filled with randomly-selected bonus symbols “20”, “15” and “18”.

Display region 204 is shown in the state adopted during the random selection for display of the symbols for the second main game. As indicated by the broken lines, the random selection and display will continue until the second vertical column, corresponding to the second main game, is filled, and until the second and fourth horizontal lines, corresponding to the free bonus games, are also filled.

The machine will then calculate and pay out awards based on the correspondence between (i) the symbols in the second vertical columns of the two regions 202 and 204, corresponding to the main game, (ii) the correspondence between the second horizontal lines in regions 202 and 204, corresponding to the first free bonus game, and (iii) the correspondence between the symbols in the fourth horizontal line, corresponding to the second free bonus game.

The horizontal lines corresponding to the free bonus games within region 202 and/or region 204 are preferably indicated in some fashion, e.g. by flashing indicia corresponding to those lines, to enable the player to recognise more easily that the free bonus games have been awarded.

At the start of the next main game, game three in the example under discussion, all the additional bonus symbols which have been selected and displayed to provide the free bonus games are erased.

Play thus continues, with the machine deciding, for each main game, which (if any) of the horizontal lines should be selected for offering a free bonus game. As a modification, the arrangement may be such that at least one bonus game is offered for each main game. According to the description set out above, at the end of the fifth game the player is awarded five bonus games corresponding to the five filled horizontal lines. In a preferred modification, after the fifth game, the player is instead awarded a random number (between zero and five, or possibly between one and five) of bonus games, the lines corresponding to the bonus games being indicated in the region 202 and/or 204. Thus, the procedure for awarding bonus games during main game five corresponds to the procedure during the other main games, except that it is not necessary to randomly select and display additional bonus symbols. Accordingly, there is no particular advantage in playing the fifth main game, as distinct from playing the other main games.

According to the arrangement described above, all bonus games are free. Instead, the player may be obliged to pay for each bonus game, and may also be given the option of declining individual bonus games.

Changing of Symbols

In the preferred embodiment, whenever the player operates one of the simulated push buttons 320 to 324, the machine makes a decision at random as to whether or not to perform a symbol changing operation. If the decision is to perform the operation, then all the existing symbols in both the region 202 and the region 204 are replaced by randomly-selected symbols. The rule that the symbols within each main game column must be unique is maintained during the random changing of the symbols.

If desired, this operation could be modified by changing only the player-selected numbers within the region 202, or only the randomly-selected numbers within the region 204.

This feature may be desirable in order to reduce the accrual of benefits or advantages from game to game. Also, because the previously-selected symbols are changed, the player cannot obtain bonus wins simply by selecting the same symbols as were selected randomly by the machine for previous games.

In accordance with a further preferred feature, a number changing operation is performed under the control of the player. This facility can be provided in addition to the random number-changing operation described above.

According to the player-initiated number changing operation, at the end of each main game, the corresponding one of the simulated buttons 320 to 324 has its indicia changed to indicate that the associated symbols may be changed by the player. Thus, referring to FIG. 3, the button 320 associated with the first main game has had its indicia changed to read “CHANGE NUMBERS”. By pressing this button, the player can cause all the player-selected numbers associated with the first main game to be changed to a randomly-selected set. As further main games are completed, the associated push buttons can be operated by the player to change the numbers in the respective columns. It will be appreciated that each time this operation is performed, any bonus sets in the region 202 will be altered.

As the main games progress, the player has a greater choice of columns for changing symbols. Preferably, the player has to make a payment in exchange for the opportunity to change the symbols within any particular column.

Various other player-initiated number-changing operations can be provided in addition to, or instead of, the operation described above. For example:
(a) Instead of changing the player-selected numbers within region 202, the randomly-selected numbers in region 204 can be changed in a corresponding manner. Alternatively, the numbers in both sets, for the selected main game, can be changed at random.
(b) The player may be provided with the opportunity to change the symbols within a horizontal bonus line. For example, any active bonus lines may be indicated in succession. If the player operates a stop button 340 at the time that a horizontal bonus line is selected, and then operates a “CHANGE BONUS NUMBERS” button 342. As a result, all the numbers in that bonus line are changed to randomly-selected numbers. This can apply to the bonus line in the player-selection region 202 and/or the bonus line in the random-selection region 204. Again, a payment may be required to use this facility.
(c) The player may be provided with the opportunity to change all the symbols currently displayed in the player-selected region 202 by operating a push button 350, or all the numbers in the machine-selection region 204 by operating a push button 352. Preferably, operation of either push button requires the preliminary payment of a stake.
(d) By operating a particular cancel push button, the player may have the ability to erase all the currently displayed symbols, so as to start a new group of main games.

Following any number-changing operation, the machine recalculates bonus wins associated with any active horizontal bonus lines. If desired, the arrangement may be such that the machine also recalculates any main game wins associated with a column in which the numbers have been changed.

Symbol Shuffling

In the arrangement described above, the player-selected symbols are added to the display region 202 sequentially, as they are selected. In an alternative embodiment, after the symbols for a main game are added in the sequence selected by the player, they are rearranged in a random sequence. Instead, the arrangement could be such that the player has to select all the symbols for a main game, those symbols then being presented in the display region in a random sequence.

In either case, this means that the player cannot simply copy previous main-game sets from the region 204 in the expectation that this will lead to a bonus win, because his selected symbols will not necessarily occupy the same horizontal bonus line as the symbols which they are copied from. (According to a further optional feature, the machine ensures that no player-selected symbol is placed on a bonus line in region 202 if the corresponding bonus line in region 204 already contains that symbol.)

Wild Card Feature

Preferably, a certain number of the machine-selected symbols are considered as wild card symbols for the purpose of calculating bonus game wins. Thus, a wild card symbol, irrespective of its actual value, will be deemed as matching any single player-selected symbol. In this way, the odds of winning the game can be influenced so as to make the game more attractive to the player. Furthermore, as the main games are progressively played, a symbol which the player had previously regarded as a losing symbol for bonus game purposes could contribute to a winning bonus game set.

The selection of symbols to be treated as wild card symbols can be achieved in a variety of different ways. For example, a number could be selected at random, and any symbols corresponding to that number can be treated as wild cards. In the illustrated preferred embodiment, however, a symbol is treated as a wild card if there is a subsequent symbol of the same value within the same bonus game set. Such wild card symbols are preferably given a distinctive appearance so they are readily visible to the player; in FIGS. 2 and 3 they are marked with a “W”.

If desired, the wild cards could also be taken into account for calculating main game wins (so in FIG. 3 the “20” symbol in the randomly-selected set for the first game would be treated as a wild card for the purpose of that game). Recalculation of wins would take place after a symbol is deemed to be a wild card.

Multi-Terminal Gaming Systems

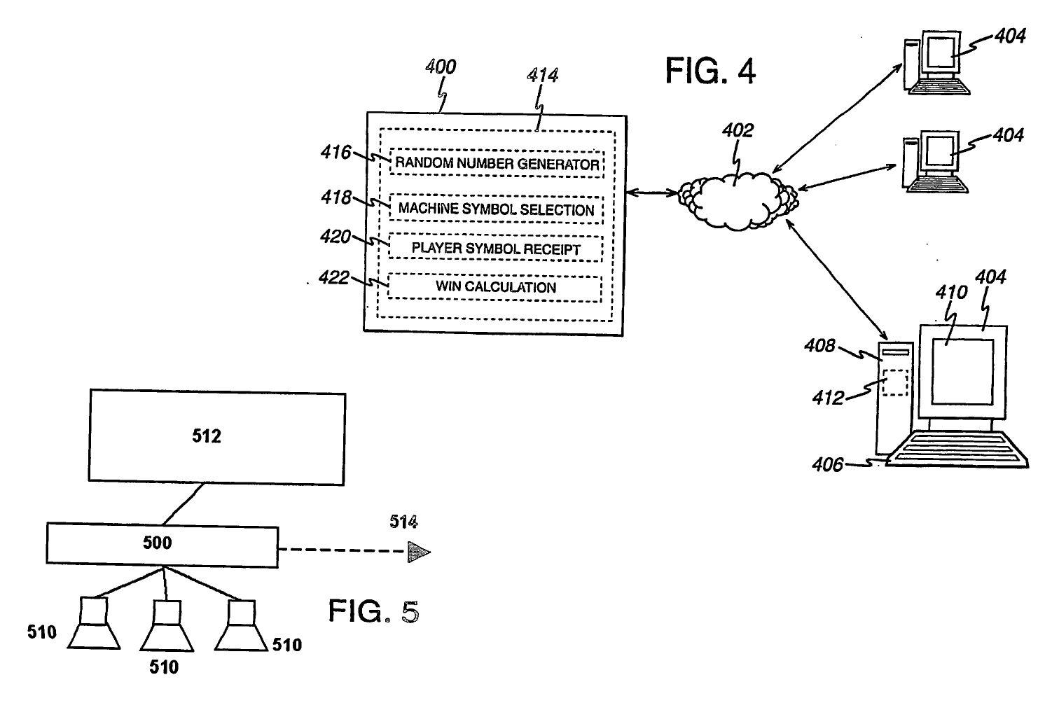

FIG. 4 shows an on-line network gaming system for playing the game described with reference to FIGS. 2 and 3. A game server 400 can be accessed via the internet schematically illustrated at 402 by multiple user terminals 404. Each user terminal 404 comprises user-entry means 406 (preferably including a keyboard and a mouse), a processing means 408 and a display 410. The processing means 408 includes user game software schematically illustrated at 412, which communicates with server software 414.

The server software 414 comprises a random number generator 416, machine symbol selection means 418 responsive to the generated random numbers for randomly selecting symbols and for transmitting data representing symbols to the user game software 412, player symbol selection receiving means 420 for receiving from the user game software 412 data representing the symbols selected by the player, and win calculation means 422 for comparing the machine symbols with the player-selected symbols, for calculating any winnings and for transmitting these to the user game software 412.

The user game software 412 responds to operation of the user entry means 406 and data received from the server software 414 for (a) transmitting player symbol selection data to the server software 414, and (b) determining the contents of an image to be displayed on the display 410, which contents may correspond to the display areas 200 and 300 of FIG. 2.

The present invention extends to server software 414 and to a server programmed with such software, and also to user game software 412, and a terminal programmed with such software.

The system need not be an on-line system. It could form what is known as a Central Gaming Server arrangement, with the terminals (which may or may not be on a single site) possibly coupled directly to the server. An example of such a system is shown in FIG. 5.

FIG. 5 shows a central controller 500 containing the necessary logic for operating the games described above. This is linked to multiple terminals 510 which allow respective players to make selections for use in playing the game. The terminals 510 may also be provided with display means for displaying the display areas 200 and 300. Alternatively, or additionally, there may be one or more main displays 512 each visible to multiple players for showing at least the region 204 containing the randomly-selected symbols.

The controller 500 may also be linked, as indicated at 514, to remote terminals, for example via telephone lines and/or the internet.

The players' games all involve a common set of randomly-selected symbols in the region 204, and each player has the ability to make symbol selections which are completely independent of the selections made by other players, so that his selections may be the same or different from the other players. This enhances the competitive aspects of the game.

Preferably, each main game is started by at timed intervals, after each player has had an opportunity to place a stake and select his symbols. Alternatively, each game starts after all the players have indicated, for example by pressing a button, that they have made their bets, although in the latter case there is preferably a limit to the amount of time permitted for this to occur.

Instead of having a central controller 500 for controlling the random selection of symbols, there could be an independently-operable gaming machine which can be played by itself, or in another mode can be linked to other independently-playable machines in a master/slave arrangement, such that when linked together the slave machines are all caused to display the same randomly-selected symbols as those of the main machine.

Possible Modifications

Instead of clearing the symbols from the regions 202 and 204 after the fifth game has finished, the symbols for the first main game could be cleared and the remainder shifted left-wise as seen in FIGS. 2 and 3. Thus, the players will then be perpetually operating as though they were playing the fifth game.

After a complete group of main games has been completed and the player continues with the next main game, the machine may decide at random whether to perform a “hold” operation, which would involve, instead of clearing all the displayed symbols, clearing only those in the first columns in regions 202 and 204 associated with the first main game. The player then has new symbols chosen for him at random by the machine for the first column in region 202, and the machine randomly selects new symbols for the first column of region 204. The main game win can be calculated as normal, and a random number of bonus games (involving the non-cleared symbols in addition to the newly-selected symbols) is then awarded.

This idea can be extended to the random performance of “hold” operations after each main game, with any randomly-selected free bonus symbols remaining effective and shown in region 204 for the subsequent game if the decision is to perform the “hold” operation.

In all the arrangements described above, it is advantageous for the symbols within each main game set (both the player-selected set and the randomly-selected set), to be arrangeable in a known sequence, so that there is no ambiguity with regard to the members of the different bonus game sets. As indicated above, the sequence could correspond to the order in which the symbols are selected. Alternatively, if the symbols themselves are selected from a larger set which have an accepted sequence, for example if they are numeric or alphabetic or representative of playing cards, they can be arranged in this sequence.

References herein to random selection are intended to cover also pseudo-random, i.e. deterministic, selection in a manner that is generally difficult to predict, as well as non-deterministic, e.g. chaotic, selection.

The player-selected symbols and the randomly-selected symbols are preferably displayed in arrays as described above, although it is to be noted that the main games and bonus games could be arranged in rows and columns, respectively, rather than columns and rows, as described above.

The invention can be embodied in any form other than those described herein, even in arrangements whose primary purpose is not game-playing, such as mobile phones or palmtop computers.

1. Gaming apparatus comprising:
a user interface comprising:
first display means for displaying a plurality of player symbols arranged in main game player sets each comprising a sequence of symbols and each corresponding to a respective one of a group of main games; and
second display means for displaying a plurality of randomly-selected symbols arranged in main game random sets each comprising a sequence of symbols and each corresponding to a respective one of said main games; and
input means operable by the user for selecting symbols to form a sequence thereof, the first display means being operable to display that sequence as a main game player set; and
processing means for selecting said randomly-selected symbols, said processing means further incorporating calculating means operable to calculate (i) a main game win for a player by comparing a main game player set with a corresponding main game random set, and (ii) a bonus game win for a player by comparing a bonus symbol set formed by the symbols at a predetermined position in the sequences of the main game player sets with a random bonus game set formed by the symbols at a predetermined position in the sequences of the main game random sets.

2. Apparatus as claimed in claim 1, wherein each of the symbols in each main game player set forms part of a respective bonus symbol set for which the calculating means is operable to calculate a win.

3. Apparatus as claimed in claim 1, wherein the machine is operable to determine at random, for each main game, whether a bonus game is to be awarded, and to perform the step of calculating a bonus game win in dependence on the result of said determination.

4. Apparatus as claimed in claim 1, wherein the machine is operable to determine, for each main game, a random number of bonus games to be awarded, and to perform the step of calculating a bonus game win for each of said random number of bonus symbol sets.

5. Apparatus as claimed in claim 13, wherein the machine is operable to randomly select symbols to supplement player-selected symbols used in previous main games in order to form one or more bonus symbol sets, the number of supplementary symbols being dependent on the number of displayed main game player sets.

6. Apparatus as claimed in claim 1, wherein the machine is operable to substitute randomly-selected symbols for already-selected symbols used in previously-played main games so as to affect subsequent bonus game win calculations.

7. Apparatus as claimed in claim 1, wherein the processing means is operable to randomly select the symbols of each main game random set using a “without replacement” procedure from a predetermined larger set, whereby the possibility of duplicate symbols within a main game random set is avoided, while duplicate symbols may appear within bonus game sets.

8. Apparatus as claimed in claim 1, wherein the machine is operable to arrange the symbols selected by the player in a random manner to obtain the sequence forming a main game player set.

9. Apparatus as claimed in claim 1, wherein, within each main game player set, the symbols are displayed in a sequence corresponding to the order in which they were selected.

10. Apparatus as claimed in claim 1, wherein the symbols within each main game player set are alpha-numerical, and are arranged within each set in alpha-numerical order.

11. Apparatus as claimed in claim 1, including means for selecting symbols to be treated by the calculating means as wild card symbols for the purpose of calculating bonus game wins.

12. Gaming apparatus comprising:
a user interface comprising input means operable by the user for selecting sequences of symbols to form main game sets, each main game set comprising symbols selected from a predetermined larger set, and display means for displaying player-selected symbols and for displaying an array of randomly-selected symbols, the symbols of the array being arranged in main game sets each corresponding to a respective main game, and the symbols within each main game set being arranged in a predetermined sequence; and
processing means for selecting said randomly-selected symbols, said processing means further incorporating calculating means, the calculating means being operable to calculate (i) a main game win for a player by comparing the player-selected main game set for a game with the randomly selected main game set for that game, and (ii) a bonus game win for a player by comparing a bonus symbol set formed by the symbols at a predetermined position in the sequences of the player-selected main game sets with a random bonus game set formed by the symbols at a predetermined position in the sequences of the randomly-selected main game sets.

13. A stand-alone gaming machine comprising gaming apparatus as claimed in claim 1, and a housing supporting the user interface and the processing means.

14. A multi-terminal gaming system comprising gaming apparatus as claimed in claim 1, the multi-terminal system comprising a server formed by said processing means, and a plurality of user terminals each comprising a respective user interface.

15. An on-line gaming system comprising a multi-terminal gaming system according to claim 14, in which the terminals are remotely located with respect to each other.

16. A multi-terminal gaming system comprising gaming apparatus as claimed in claim 1, the multi-terminal system comprising a server formed by said processing means, a plurality of user terminals each comprising a respective first display means and input means, and a display device including said second display means, the display device being visible to users of said terminals.

17. Computer apparatus programmed to operate as a server for a multi-terminal system as claimed in claim 14.
